(19) United States
(12) Patent Application Publication
(10) Pub. No.: US 2015/0070126 A1
(43) Pub. Date: Mar. 12, 2015

(54) THERMAL FUSE DEVICE

(71) Applicant: Johnson Electric S.A., Murten (CH)

(72) Inventor: Marco Bussa, Viarigi (IT)

(21) Appl. No.: 14/482,334

(22) Filed: Sep. 10, 2014

(30) Foreign Application Priority Data
Sep. 10, 2013 (IT) TO2013U000139

(51) Int. Cl. H01H 37/64; H01H 37/32

(52) U.S. Cl. CPC H01H 37/64; H01H 37/32
USPC 337/413

(57) ABSTRACT

A thermal fuse device has an essentially annular frame made of electrically insulating material. First and second contact strips of electrically conductive material extend through opposite portions of the frame and have respective first ends extending inside the internal region of the frame, where they at least partially face each other, and respective second ends extending outside the frame for connection to an electrical or electronic circuit. The first end of the first contact strip is joined to the first end of the second contact strip by a quantity of heat-meltable material, in a condition where the first contact strip is resiliently pre-stressed so that, when the joint is broken, the first end of the first contact strip moves away from the first end of the second contact strip.

### CROSS REFERENCE TO RELATED APPLICATIONS

This non-provisional patent application claims priority under 35 U.S.C. §119(a) from Utility Model Application No. TO2013U000139 filed in Italy on Sep. 10, 2013, the entire contents of which are hereby incorporated by reference.

### FIELD OF THE INVENTION

The present invention relates to a thermal fuse device, in particular for use in electronic circuits.

### BACKGROUND OF THE INVENTION

Electric and electronic circuits require a fuse to limit damage caused by overheating situations. Thermal protection is important for electronic circuits as extremely temperatures can permanently damage the components. However, current thermal devices are either bulky and difficult to install or are very expensive, resulting in only expensive or critical circuits being protected.

Hence there is a need for a thermal fuse device which has a simple structure, can be manufactured at a low cost, can be readily connected to the operating circuit and is highly reliable in terms of operation.

### SUMMARY OF THE INVENTION

Accordingly, in one aspect thereof, the present invention provides a thermal fuse device, in particular for electronic circuits, comprising: a support frame made of electrically insulating material and having an essentially annular form; and first and second contact strips which are made of electrically conductive material and extend through opposite portions of the frame and which have respective first ends extending inside the internal region of the frame, where they at least partially face each other, and respective second ends extending outside the frame for connection to an electrical or electronic operating circuit; wherein the first end of the first contact strip is joined to the first end of the second contact strip, by a quantity of electrically conductive, heat-meltable material in a condition where the first contact strip is resiliently pre-stressed so that, when the heat-meltable material melts, the first end of the first contact strip moves away from the first end of the second contact strip.

Preferably, the support frame is a molded plastic part and the first and second contact strips are partly incorporated in and fastened to the support frame during molding of the latter.

Preferably, the first end of the first contact strip is joined to the corresponding end of the second contact strip in a condition resiliently pre-stressed transversely towards the first end of the second contact strip and axially away from the first end of the second contact strip so that, when the heat-meltable material melts, the first end of the first contact strip tends to move away transversely and slide axially towards the first end of the second contact strip.

Preferably, the first end of the second contact strip has a cavity or recess directed towards the first end of the first contact strip, so as to receive and retain part of the heat-meltable material.

Preferably, the first end of the first contact strip has a through-opening facing the first end of the second contact strip, so as to receive and retain part of the heat-meltable material.

Preferably, the contact strips are made with a copper and beryllium alloy.

Preferably, the heat-meltable material is a tin-based alloy.

Preferably, the first ends of the contact strips are joined together by a soldering process.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a perspective view of a thermal fuse device according to the present invention shown in a condition prior to connecting together of the first ends of its contact strips;

FIG. 2 is another view of the thermal fuse device of FIG. 1 showing the first ends of its contact strips in the operating condition soldered together; and

FIG. 3 is a perspective view of an electronic circuit provided with a thermal fuse device according to the invention.

### DETAILED DESCRIPTION OF THE PREFERRED EMBODIMENTS

In the drawings a thermal fuse device according to the preferred embodiment of the present invention is denoted overall by 1.

In the preferred embodiment shown, the thermal fuse device 1 comprises a support frame 2 made of electrically insulating material, in particular an injection-molded plastic. The support frame 2 has an essentially annular—in particular and preferably rectangular—form with two longer sides 2a and two shorter sides 2b.

The thermal fuse device 1 also comprises first and second contact strips 3 and 4 made of electrically conductive material, for example a beryllium alloy. These contact strips which extend through opposite portions or sides 2b of the support frame 2 have respective first ends 3a, 4a extending inside the internal region of the frame 2, where they at least partly face each other, and respective second ends 3b, 4b extending outside the frame 2 for connection to an electrical or electronic operating circuit.

Conveniently the contact strips 3 and 4 are connected and fastened inside the support frame 2 during the operation for molding the frame.

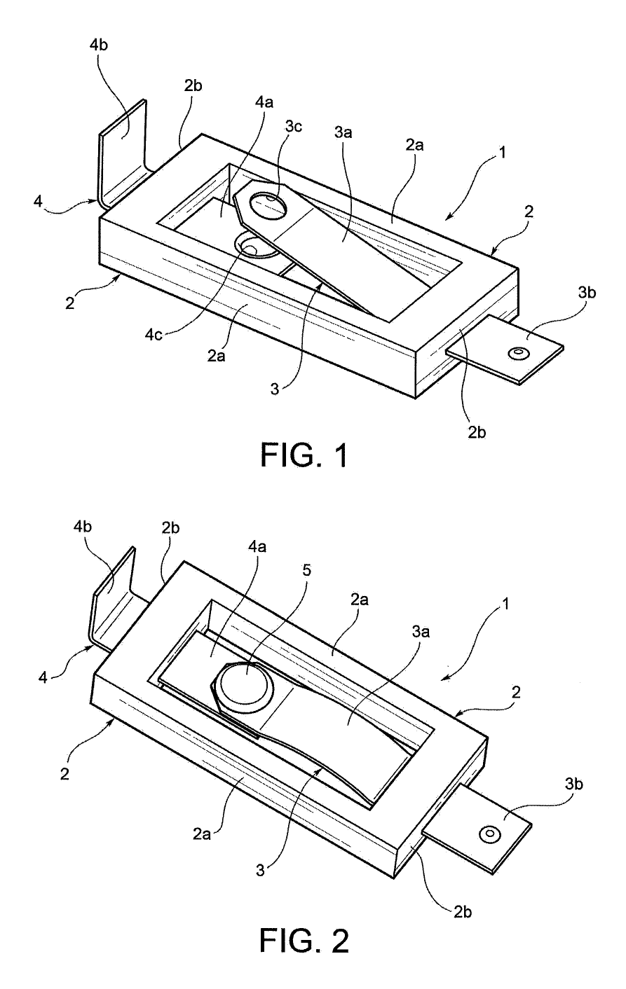

Preferably, as shown in FIG. 1, the first contact strip 3 is shaped so that, before soldering, the first end 3a is partially facing the corresponding first end 4a of the second contact strip 4, but at a distance therefrom.

In the embodiment shown, the end 4a of the second contact strip 4 has a cavity or recess 4c directed towards the first end 3a of the first contact strip 3. Moreover the end 3a of the first contact strip 3 has conveniently a through-opening 3c.

The end 3a of the contact strip 3 is then soldered to the end 4a of the contact strip 4 using a quantity of a heat-meltable material indicated by 5 in FIG. 2. This material is, for example, a tin-based alloy and is received partly inside the cavity 4c of the contact strip 4 and partly also inside the opening 3c of the contact strip 3.

Conveniently the arrangement is such that, for the purposes of soldering, the end 3a of the first contact strip 3 is resiliently pre-stressed transversely towards the end 4a of the contact strip 4. Preferably, the portion 3a of the contact strip 3 is also pre-stressed axially away from the end 4a of the contact strip 4 such that, after the soldered joint has been formed, the portion 3a of the contact strip 3 assumes an arched configuration, as can be seen in FIG. 2.

Owing to the resilient pre-stressing mentioned above, when the soldered joint is broken, the end portion 3a of the contact strip 3 tends to slide axially towards and transversely away from the end 4a of the second contact strip 4. Generally speaking the end 3a of the contact strip 3 therefore moves away from the end 4a of the contact strip 4.

As a result it is possible to ensure stable mechanical—and in particular electrical—separation of the contact strips 3 and 4 when the soldered joint is broken. As should be understood, the joint is broken when the heat-meltable material 5 melts, as would occur when the device gets too hot causing the material to reach melting point. The amount and composition of the heat-meltable material can be chosen so as to melt at a predetermined temperature.

As may be readily understood from FIGS. 1 and 2, the thermal fuse device 1 according to the invention has an extremely simple structure and can be manufactured easily and at a low cost. Also the installation of the thermal fuse device in the operating circuit is extremely easy.

The sides 2a of the support frame 2 also help protect the contact strips 3 and 4 from accidental contact with other parts of the operating circuit.

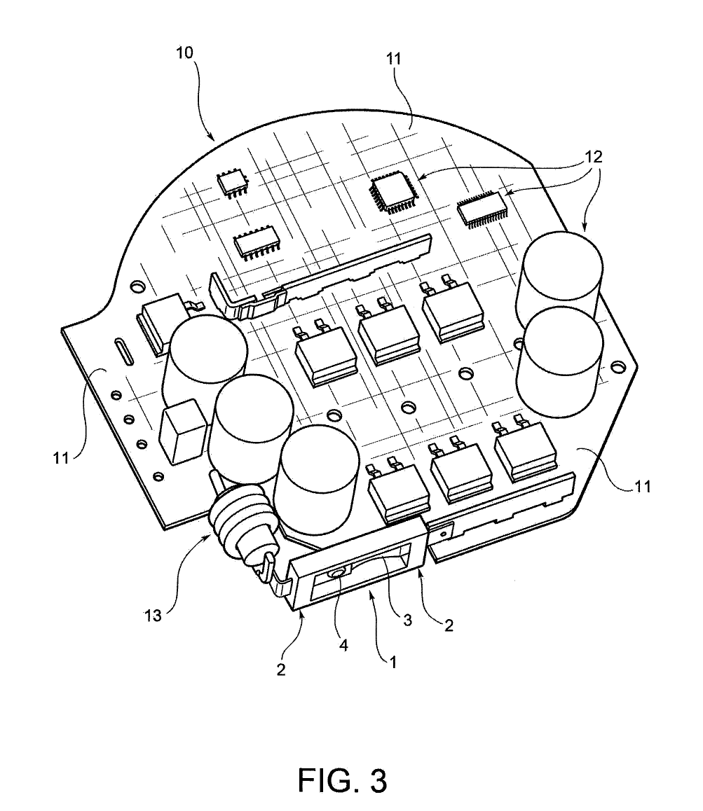

FIG. 3 shows an electronic circuit—denoted overall by 10—which includes a circuit board 11 housing a number of electrical/electronic components indicated overall by 12. These components include in particular a power supply component 13 which powers the whole board.

The electronic circuit 10 shown in FIG. 3 comprises a thermal fuse device 1 according to the present invention which is conveniently connected directly to the power supply component 13.

As can be seen from FIG. 3, the thermal fuse device 1 has compact dimensions and may be easily connected within the operating circuit via the ends 3b, 4b of its contact strips 3 and 4 which act as proper connection terminals.

Obviously, without modifying the principle of the invention, the embodiments and the constructional details may be greatly varied with respect to that described and illustrated purely by way of a non-limiting example, without thereby departing from the scope of the invention as defined in the accompanying claims.

In the description and claims of the present application, each of the verbs “comprise”, “include”, “contain” and “have”, and variations thereof, are used in an inclusive sense, to specify the presence of the stated item or feature but do not preclude the presence of additional items or features.

1. Thermal fuse device, in particular for electronic circuits, comprising:
a support frame made of electrically insulating material and having an essentially annular form; and
first and second contact strips which are made of electrically conductive material and extend through opposite portions of said frame and which have respective first ends extending inside the internal region of said frame, where they at least partially face each other, and respective second ends extending outside the frame for connection to an electrical or electronic operating circuit;
wherein the first end of the first contact strip is joined to the first end of the second contact strip, by a quantity of electrically conductive, heat-meltable material in a condition where the first contact strip is resiliently pre-stressed so that, when the heat-meltable material melts, the first end of the first contact strip moves away from the first end of the second contact strip.

2. The thermal fuse device of claim 1, wherein the support frame is a molded plastic part and the first and second contact strips are partly incorporated in and fastened to the support frame during molding of the latter.

3. The thermal fuse device of claim 1, wherein the first end of the first contact strip is joined to the corresponding end of the second contact strip in a condition resiliently pre-stressed transversely towards the first end of the second contact strip and axially away from the first end of the second contact strip so that, when the heat-meltable material melts, the first end of the first contact strip tends to move away transversely and slide axially towards the first end of the second contact strip.

4. The thermal fuse device of claim 1, wherein the first end of the second contact strip has a cavity or recess directed towards the first end of the first contact strip, so as to receive and retain part of the heat-meltable material.

5. The thermal fuse device of claim 1, wherein the first end of the first contact strip has a through-opening facing the first end of the second contact strip, so as to receive and retain part of the heat-meltable material.

6. The thermal fuse device of claim 1, wherein said contact strips are made with a copper and beryllium alloy.

7. The thermal fuse device of claim 1, wherein the heat-meltable material is a tin-based alloy.

8. The thermal fuse device of claim 1, wherein the first ends of the contact strips are joined together by a soldering process.
